(19) United States
(12) Patent Application Publication
(10) Pub. No.: US 2026/0241942 A1
(43) Pub. Date: Aug. 20, 2026

(54) A SYSTEM AND METHOD FOR FAULT PREDICTION BY USING FUEL CONSUMPTION DATA IN CONSTRUCTION MACHINERY

(71) Applicant: BORUSAN MAKINA VE GUC SISTEMLERI SANAYI VE TICARET ANONIM SIRKETI, Istanbul (TR)

(72) Inventors: Esra AKCA, Istanbul (TR); Yasin DINC, Istanbul (TR); Nermin YALCI, Istanbul (TR)

(73) Assignee: BORUSAN MAKINA VE GUC SISTEMLERI SANAYI VE TICARET ANONIM SIRKETI, Istanbul (TR)

(21) Appl. No.: 19/469,373

(22) PCT Filed: Mar. 27, 2024
(86) PCT No.: PCT/TR2024/050309

§ 371 Date: Sep. 26, 2025

(30) Foreign Application Priority Data
Mar. 31, 2023 (TR) 2023/003556

(51) Int. Cl. B60W 50/02

(52) U.S. Cl. CPC B60W 50/0205; B60W 2510/0623

(57) ABSTRACT

The invention relates to the calculation of fuel consumption per unit hour by real-timely analyzing the fuel consumption data of construction equipment with the Internet of Things (IoT) technology; the invention relates to a method and a system working according to the said method, which enables the calculation of fuel consumption per unit hour and the real-time processing of fuel data in the cloud computing system to make fault prediction and thus to share it with the relevant business units, to make fault prediction in long periods based on person-independent algorithm bases, to be followed up in a versatile and digital way by means of a platform operating on a sensor and computing device operating on construction machinery.

### TECHNICAL FIELD

The invention relates to the calculation of the fuel consumption per unit hour by analyzing the fuel consumption data of construction machines real-timely with the Internet of Things (IoT) technology and real-time fuel data can be processed in the cloud computing system and failure prediction can be made and thus to be shared with the relevant business units, to make failure predictions in long periods by means of a sensor operating on construction machinery and a platform operating on the computing device, based on person-independent algorithm bases, it is related to a method that allows multi-directional and digital tracking and a system that works according to the method in question.

### STATE OF THE ART

Fuel consumption is the amount of fuel consumed by motor vehicles under various conditions during use. Fuel consumption per kilometer can be calculated on the vehicle trip computer. The value written on the display shows the amount of fuel you consume within 100 kilometers.

Fuel consumption is regularly checked by the user, but the calculated fuel consumption data cannot go beyond the real-time and average fuel consumption by the user. Fuel consumption data in motor vehicles can give clues about malfunctions. Fuel consumption data changing with the behavior of the user in motor vehicles can be a sign of certain malfunctions. In such cases, recognizing the sign in question and intervening early can prevent serious problems and costs in the future and significantly reduce air pollution.

In the known state of the art, a clear diagnosis cannot be made for fault detection with real-time fuel consumption data. Failure to be recognized by the user before the failure causes larger failures, disruption of the operational process, harmful gases into the air and increased air pollution.

In the patent No. IN201911045310A, relates to an IoT (Internet of Things) based fuel management system. The invention herein provides advanced analytics based on fuel level data available in real time over the internet for any machine consuming fuel at any given time, such as refueling, fuel stock, fuel essence and fuel consumption data. However, the solution disclosed herein does not solve the problem of predicting the malfunction from the fuel consumption data, detecting the malfunction without the need for knowledge and experience of the technical personnel and preventing the loss of time to come to the service.

In the patent No. CN102325176A, presents an IoT (Internet of Things) system and a fuel quantity monitoring method. The invention is used to determine the insufficient fuel amount according to the fuel amount of the vehicle, and then to receive the location information of a fuel station according to the location information of the vehicle and to send the location information. The invention provides an increase in vehicle driving safety. The fuel consumption data obtained does not disclose the fault prediction or the prediction of the situation of going to the service.

In the patent No. TR2021/008757, is related to the system that monitors the fuel consumption data of the vehicles within the company on the basis of liters and prices and analyses these data with machine learning techniques to create predictions for fuel consumption in future periods. However, this disclosed system does not explain the ability to predict malfunctions by using real-time fuel consumption data with the IoT (Internet of Things) system.

In the patent No. CN110274650A, provides an IoT (Internet of Things) based fuel consumption management system and relates to the field of vehicle fuel consumption management. The invention includes a data sensor device, a control device, a fuel consumption meter electrically connected to the control device, a fluid level sensor, a communication module, and a GPS module, and is connected to a cloud server via a network. The fuel consumption management system realizes the function of remote vehicle oil consumption monitoring and metering more precisely than the prior art. However, the invention does not disclose the ability to predict malfunctions in construction equipment using real-time fuel consumption data.

In the above-mentioned patent documents and many more, fuel consumption analysis systems and methods are disclosed. However, these disclosed inventions do not propose a solution such as failure prediction by comparing the fuel consumption data per unit hour with the characteristics of the construction equipment.

As a result, there are studies for fault detection that have been developed or are in use in the current technique. However, a solution that will enable the CRM system to learn fault detection without going to the service center and to provide a diagnosis with fuel consumption data has not yet emerged.

There is a need to develop new methods to overcome the disadvantages of the known state of the art.

### OBJECTIVES AND BRIEF DESCRIPTION OF THE INVENTION

The purpose of the invention is to obtain a method and a system operating according to the method in question, which allows failure prediction with fuel consumption data obtained real-timely from the sensors in the construction machines via the Internet of Things (IoT).

Another aim of the invention is to base manual processes on person-independent algorithms and to monitor them digitally and in multiple ways.

Another object of the invention is to minimize the time when the machines are inoperable and to prevent the loss of time for customers to come to the service.

Another object of the invention is to increase the fuel efficiency of the construction machines, to consume less fuel and to protect the environment by preventing the emission of less harmful gases into the air.

With fault detection, technical personnel and spare parts requirements are determined according to the nature of the fault, reducing logistics and personnel costs. By sending the right personnel to the right job, planning errors are minimized and the time spent on standby is improved. Therefore, the invention also provides labor, time, and cost advantages.

In order to realize the above-mentioned objects, the invention is a system that enables fault detection by using real-time fuel consumption data in construction machinery and the following.
at least one sensor unit that measures real-time fuel consumption data,
at least one data transmission device that continuously transmits the data from the said sensor unit to other components,
at least one data warehouse that analyzes the fuel consumption data and converts it into a suitable format,
at least one server that develops prediction algorithms using machine learning methods,
within the said server, a learning component that analyzes real-time fuel consumption data and determines the prediction algorithm,
within the said server, a prediction component that runs the algorithm selected by the said learning component.

The said sensor unit is a fuel flow measurement sensor.

The said data transmission device is equipped with Internet of Things (IoT) technology.

It a CRM system that records and displays the results coming from the said prediction component through the said server, and is in real-time integration with the prediction component.

The invention also relates to a method that allows for the detection of faults in construction machinery by utilizing real-time fuel consumption data and the following process steps.
real-time measurement of fuel consumption by the sensing unit during the operation of the construction machine,
transfer of the real-timely measured data from the sensing unit to the data warehouse by the data transmission device,
analysis of the real-time fuel data arriving at the data warehouse and detection of the presence of a fault due to abnormal data,
conversion of the detected abnormal data into an appropriate format and transfer to the server,
selection of a suitable prediction model by the learning component for the data coming from the data warehouse,
execution of the selected prediction model by the prediction component and calculation of how many working hours later the fault will occur.

In addition, the method of the invention further the step of, after determining when the fault will occur in terms of operating hours, sending the fault detection information to the CRM system via a server for recording.

In the method of the invention, the analysis performed in the data warehouse is carried out by comparing the incoming real-time fuel data with the hourly fuel consumption data specific to the construction machinery

### BRIEF DESCRIPTION OF DRAWINGS

FIG. 1, views the system components of the system subject to the invention and the relationship between them.

FIG. 2, views a flow diagram showing the process steps of the method subject to the invention.

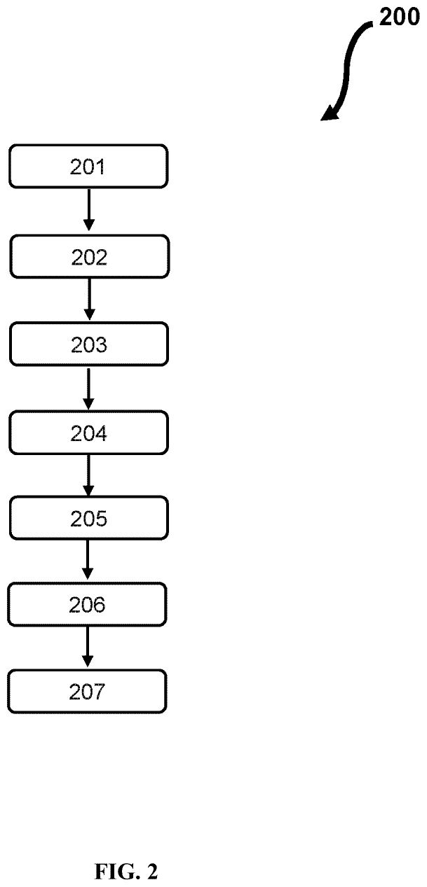

### Reference Numbers

100. Prediction system
10. Sensor Unit
20. Data Transmission Device
30. Data Warehouse
40. Server
40.1 Learning Component
40.2 Prediction Component
50. CRM System
200. Method
201. Real-time measurement of fuel consumption by the sensor unit during the operation of the construction machine
202. Transfer of data, measured real-timely by the sensor unit, to the data warehouse by the Data transmission device
203. Analysis of the real-time fuel data arriving at the data warehouse
204. Detection of abnormal values during the analysis, conversion of the data into an appropriate format, and transfer to the server
205. Selection of a suitable prediction model by the learning component in the server based on the data received from the data warehouse
206. Execution of the selected prediction model by the prediction component and detection of the presence of a malfunction
207. Following the detection of the malfunction, sending the malfunction detection information to the CRM system via the server for recording

### DETAILED DESCRIPTION OF THE INVENTION

The invention relates to a method (200) and system (100) for predicting a malfunction of construction machinery, which enables early fault detection and identification of maintenance needs of construction machinery by analyzing the fuel consumed real-timely during operation.

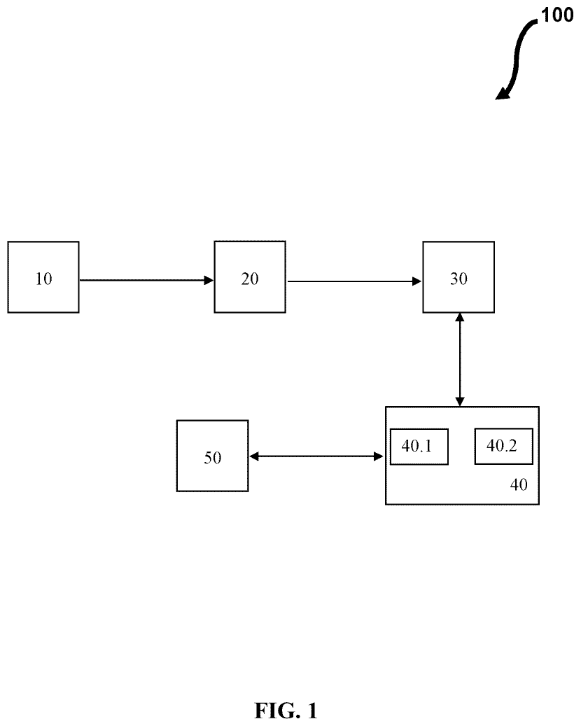

The system components of the inventive system and the relationship between these components are schematized in FIG. 1. The prediction system (100) generally comprises the following.
at least one sensor unit (10) that measures real-time fuel consumption data,
at least one data transmission device (20) that continuously transmits the data from the said sensor unit (10) to other components,
at least one data warehouse (30) that analyzes the fuel consumption data and converts it into a suitable format,
at least one server (40) that develops prediction algorithms using machine learning methods,
within the said server (40), a learning component (40.1) that analyzes realtime fuel consumption data and determines the prediction algorithm, within the said server (40), a prediction component (40.2) that runs the algorithm selected by the said learning component (40.1).

There is a sensor unit (10) is located within the construction machinery to monitor realtime fuel consumption. This sensor unit (10), preferably a sensor, is typically positioned near the fuel line or fuel tank of the machinery. The sensor unit (10) measures the fuel flow and transmits this information to the data transmission device (20). The data transmission device (20), situated within the machinery, is any device that incorporates Internet of Things (IoT) technology. This data transmission device (20) real-timely transfers the data received from the sensor unit (10) to the data warehouse (30)

The data warehouse (30) primarily serves two functions;
The first function involves converting real-time fuel consumption data into a more suitable format, making it readable on the server (40).
The second function is to monitor the data received from the data transmission device (20) during the operation of the construction machinery in real time. It determines whether these data fall within the hourly fuel consumption values specified for the machine/model.

It is crucial for the machine/model information used in performing the second function, and the hourly fuel consumption data determined for each machine/model, to be up-to-date. These data are continuously updated by the server (40) and transferred to the data warehouse (30). In the mentioned detection process, the hourly fuel consumption data used is also the fuel consumption rate per unit hour. It is calculated by dividing the total consumed fuel (in gallons) by the total operating hours. These calculations are performed by the server (40). In addition, these calculations are updated by considering the sectors in which construction equipment is used and the areas and geographical conditions used accordingly. Furthermore, these calculations are updated considering the sectors in which the construction machinery is used, as well as the specific applications and geographical conditions. For instance, the fuel consumption of a construction machine operating on rugged terrain will differ from that of a machine working on flat ground. Similarly, the fuel consumption of an underground mining machine will significantly vary from that of a machine operating at high altitudes on a construction site. It is assumed here that the machines being exemplified are the same When the data warehouse (30) observes an increase in the flowing real-time fuel consumption data above the fuel consumption values per unit hour, it transfers this deviated data to the server (40). The server (40) contains a learning component (40.1) and a prediction component (40.2). The learning component (40.1) in the server (40) is the component that trains a prediction model. The learning component (40.1) performs the learning process on the dataset using several training algorithms or models.

The learning component (40.1) follows the following alternative paths when predicting the number of working hours after which the construction machine will fail:
modeling the relationship between failure probability and fuel consumption data,
building a decision tree using features from a dataset (drawing a path to predict the probability of a failure by creating a branch for each feature in the dataset),
fault prediction using mathematical models with artificial neural networks method.

One or more of the above models can be used to predict failure from fuel consumption data. However, there are many models in the learning component (40.1) and it keeps itself updated by continuously improving and comparing with various models to give the most accurate result. The model selected by the learning component (40.1) is passed to the prediction component (40.2) for use.

The prediction component (40.2) can perform many different operations such as classifying, identifying, predicting, or discovering new data using a pre-trained model. The prediction component (40.2) uses the model from the learning component (40.1) to make a prediction based on the given input data.

The prediction results obtained by the prediction component (40.2) are transferred to the CRM (50) system. Users, either service personnel or directly the customer himself, can view these results on a specific page in the CRM (50) system or export them as a report. The results enable the service personnel to help them focus on the right customer at the right time.

The method (200) developed for predicting faults in construction machinery using fuel consumption data comprises the following steps:
real-time measurement of fuel consumption by the sensing unit (10) during the operation of the construction machine (201),
transfer of the real-timely measured data from the sensing unit (10) to the data warehouse (30) by the data transmission device (20) (202),
analysis of the real-time fuel data arriving at the data warehouse (30) and detection of the presence of a fault due to abnormal data (203),
conversion of the detected abnormal data into an appropriate format and transfer to the server (40) (204),
selection of a suitable prediction model by the learning component (40.1) for the data coming from the data warehouse (30) (205),
execution of the selected prediction model by the prediction component (40.2) and calculation of how many working hours later the fault will occur (206).
following the detection of the malfunction, sending the malfunction detection information to the CRM (50) system via the server (40) for recording (207).

The learning component (40.1) within the server (40) continuously processes realtime data, receiving a constant stream of updated data, thereby enabling the fault prediction system (100) to continuously train itself. As a result, the obtained predictions are continuously improved.

What is claimed is:

1. A system (100) for diagnosing malfunctions in construction machinery using realtime fuel consumption data, characterized by comprising
at least one sensor unit (10) that measures real-time fuel consumption data,
at least one data transmission device (20) that continuously transmits the data from the said sensor unit (10) to other components,
at least one data warehouse (30) that analyzes the fuel consumption data and converts it into a suitable format,
at least one server (40) that develops prediction algorithms using machine learning methods,
within the said server (40), a learning component (40.1) that analyzes realtime fuel consumption data and determines the prediction algorithm,
within the said server (40), a prediction component (40.2) that runs the algorithm selected by the said learning component (40.1).

2. The system (100) according to claim 1, wherein it comprises a sensor unit (10) is a fuel flow measurement sensor.

3. The system (100) according to claim 1, wherein it comprises a data transmission device (20) has Internet of Things (IoT) technology.

4. The system (100) according to claim 1, wherein it comprises a CRM system (50) that records and displays the results coming from the said prediction component (40.1) through the said server (40), and is in real-time integration with the prediction component (40.2).

5. A method (200) for diagnosing malfunctions in construction machinery using realtime fuel consumption data, characterized by comprising
real-time measurement of fuel consumption by the sensing unit (10) during the operation of the construction machine (201),
transfer of the real-timely measured data from the sensing unit (10) to the data warehouse

(30) by the data transmission device (20) (202),
analysis of the real-time fuel data arriving at the data warehouse (30) and detection of the presence of a fault due to abnormal data (203),
conversion of the detected abnormal data into an appropriate format and transfer to the server (40) (204),
selection of a suitable prediction model by the learning component (40.1) for the data coming from the data warehouse (30) (205),
execution of the selected prediction model by the prediction component (40.2) and calculation of how many working hours later the fault will occur (206).

6. The fault detection method (200) according to claim 5, wherein it comprises the process step of determining how many working hours after which the fault will occur, and then sending the fault detection information to the CRM system (50) via the server (40) and recording it (207).

7. The fault detection method (200) according to claim 5, wherein it comprises the analysis carried out in the data warehouse (30) is carried out by comparing the incoming real-time fuel data with the hourly fuel consumption data of the construction machine.
